(19) United States
(12) Patent Application Publication
(10) Pub. No.: US 2015/0098700 A1
(43) Pub. Date: Apr. 9, 2015

(54) Distributed Optical Switching Architecture for Data Center Networking

(71) Applicant: Coadna Photonics Inc., Sunnyvale, CA (US)

(72) Inventors: Zhonghua Zhu, Highland, MD (US); Shan Zhong, Clarksville, MD (US)

(73) Assignee: Coadna Photonics Inc., Sunnyvale, CA (US)

(21) Appl. No.: 14/506,466

(22) Filed: Oct. 3, 2014

Related U.S. Application Data
(60) Provisional application No. 61/886,553, filed on Oct. 3, 2013.

(51) Int. Cl. H04Q 11/00

(52) U.S. Cl. CPC H04Q 11/0005; H04Q 2011/0052; H04Q 2011/0016
USPC 398/48

(57) ABSTRACT

A system has a first rack with a first set of servers and a first top of rack switch and a second rack with a second set of servers and a second top of rack switch. A first optical switch is connected to the first top of rack switch. A second optical switch is connected to the second top of rack switch and the first optical switch. The first optical switch and the second optical switch each employ wavelength selective switching.

### CROSS-REFERENCE TO RELATED APPLICATION

This application claims priority to U.S. Provisional Patent Application Ser. No. 61/886,553, filed Oct. 3, 2013, the contents of which are incorporated herein by reference.

### FIELD OF THE INVENTION

This invention relates generally to data communications. More particularly, this invention relates to a distributed optical switching architecture for data center networking.

### BACKGROUND OF THE INVENTION

“Big data” is prevalent. There is exponentially increasing computing and storage needs for big data. Cloud architectures are commonly used to address big data challenges. In a data center, server and storage resources are interconnected with packet switches and routers which provide the basic internal data center networking functionality. Data centers are also interconnected across wide area networks through routing and transport systems known as the cloud.

Data centers can be of three types: private, public or virtually private. The size of data centers varies too. Tier 1 data centers may contain thousands of racks and millions of servers. Tier 2 data centers could host hundreds of thousands of servers with the number of racks ranging from 250 to 2000. Tier 3 and 4 data centers have less than 250 racks.

A conventional data center network typically has a hierarchical architecture. Each rack of servers connects to a top of rack (TOR) Ethernet switch, which is usually considered an access switch. A plurality of such top of rack switches connect to a higher level of Ethernet switch, which is generally referred as an aggregation switch. The aggregation switch provides a packet switching function among its down layer and its uplinks A plurality of such top of rack switches further connects to a higher level of Ethernet switch with their uplinks; this type of hierarchy repeats. The highest level of the Ethernet switch is generally referred to as the core switch. In addition, a gateway provides inter-data center connectivity and connectivity to the Internet and end users.

FIG. 1 illustrates a conventional hierarchical data center network. A set of servers in a rack have a TOR 100, which connects to access switches 102, which connect to core switches 104, which connect to the internet 106. This hierarchical architecture suffers from increasing complexity, particularly as the data center scales. For example, cabling becomes an un-resolvable issue as the number of links increases along with the number of hierarchical layers and server numbers. Nevertheless, long-distance cabling is inevitable and becomes an unavoidable burden associated with data center construction and maintenance costs. Furthermore, electrical switches usually consume tens of watts per switch port. The per port power consumption continuously increases as the line rate per switching port increases from 1 Gb/s to 10 Gb/s, even 100 Gb/s in the near future.

It is becoming increasingly important to reduce the total power consumption inside data centers. To address these problems, large scale electrical switches were developed to handle hundreds and thousands of 10G ports in a single chassis. Such architecture has the benefit of fewer hierarchical layers, reduced power consumption and simpler cabling structure. FIG. 2 illustrates a flattened architecture where TOR switches 100 connect to core switches 104, which connect to the internet 106. Still, fundamental problems remain.

Optical networking technology is well known in the telecom and datacom worlds. Optical links support large capacity transmission over long distances. Optical based channel switching or wavelength switching can provide fast switching speed at much lower power consumption. Thus, optical networking technology is well suited to resolve existing challenges in data centers. Two basic approaches have already been proposed based on different optical switching components.

FIG. 3 illustrates one prior art architecture with TOR switches 100 connected to a core switch 300 and optical circuit switches 302. FIG. 4 illustrates a set of TOR switches 100 connected by Optical Add/Drop Multiplexers (OADMs) 400.

### SUMMARY OF THE INVENTION

A system has a first rack with a first set of servers and a first top of rack switch and a second rack with a second set of servers and a second top of rack switch. A first optical switch is connected to the first top of rack switch. A second optical switch is connected to the second top of rack switch and the first optical switch. The first optical switch and the second optical switch each employ wavelength selective switching.

### BRIEF DESCRIPTION OF THE FIGURES

The invention is more fully appreciated in connection with the following detailed description taken in conjunction with the accompanying drawings, in which:

FIG. 1 illustrates a conventional prior art hierarchical data center.

FIG. 2 illustrates a prior art data center with a flattened architecture.

FIG. 3 illustrates a prior art hybrid packet and optical switching data center architecture.

FIG. 4 illustrates a prior art data center with Optical Add/Drop Multiplexers.

FIG. 5 illustrates a data center configured in accordance with an embodiment of the invention.

FIG. 6 illustrates an optical switch with wavelength selective switching utilized in accordance with an embodiment of the invention.

FIG. 7 illustrates an array waveguide grating router with a tunable filter array utilized in accordance with an embodiment of the invention.

FIG. 8 illustrates wavelength shuffling performed by an array waveguide grating router.

FIG. 9 illustrates an optical switch with a filter array utilized in accordance with an embodiment of the invention.

FIG. 10 illustrates port mapping of a passive routing fabric utilized in accordance with an embodiment of the invention.

FIG. 11 illustrates a two dimensional torus cable connection utilized in accordance with an embodiment of the invention.

FIG. 12 illustrates an array where each circle represents a fully meshed connected group utilized in accordance with an embodiment of the invention.

FIG. 13 illustrates a folded two dimensional torus cable connection utilized in accordance with an embodiment of the invention.

FIG. 14 illustrates end of row optical switching.

FIG. 15 illustrates an array waveguide grating router with broadcasted signals.

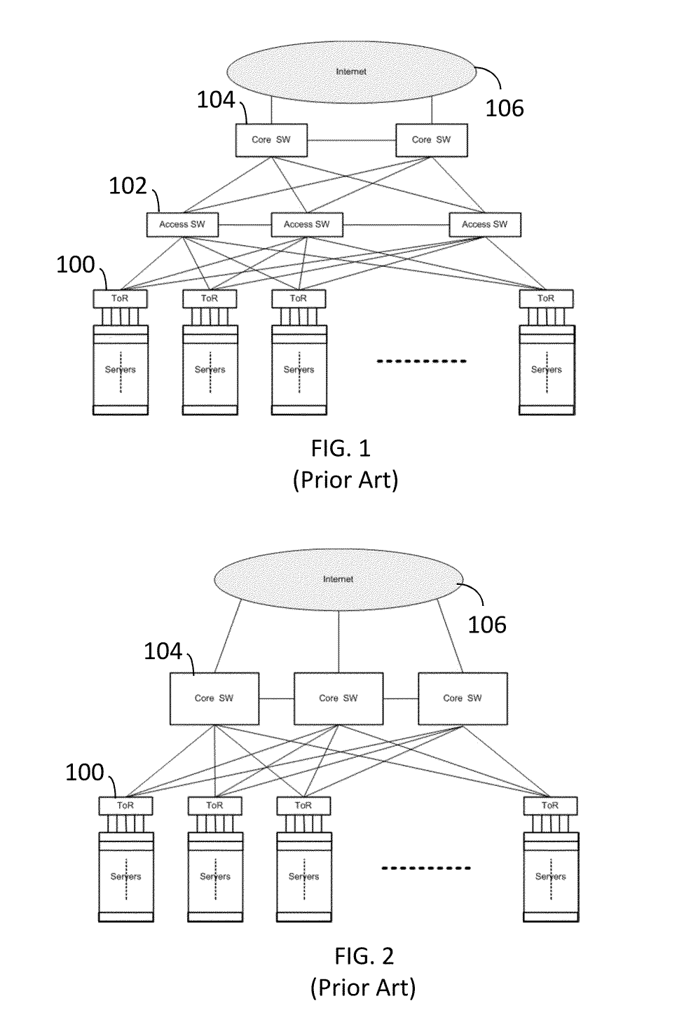

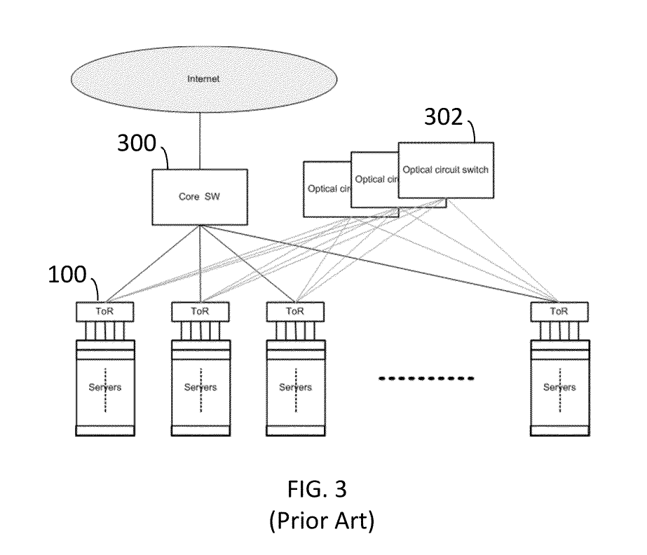

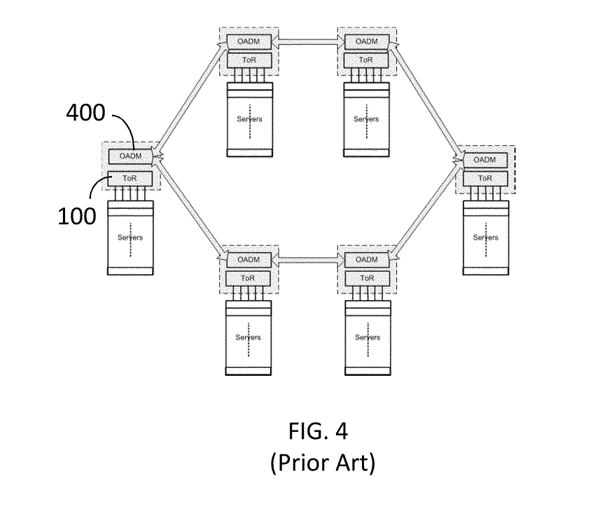

Like reference numerals refer to corresponding parts throughout the several views of the drawings.

### DETAILED DESCRIPTION OF THE INVENTION

A multiple dimension and high radix optical distributed switching network architecture for internal data center interconnections is disclosed. The link capacity in this distributed switching network is also optically reconfigurable to be adaptive to the dynamic pattern of internal data center traffic. The solution is naturally scalable to support thousands of servers (e.g., Tiers 3&4 data centers) to millions of servers (e.g., Tier 1 data centers).

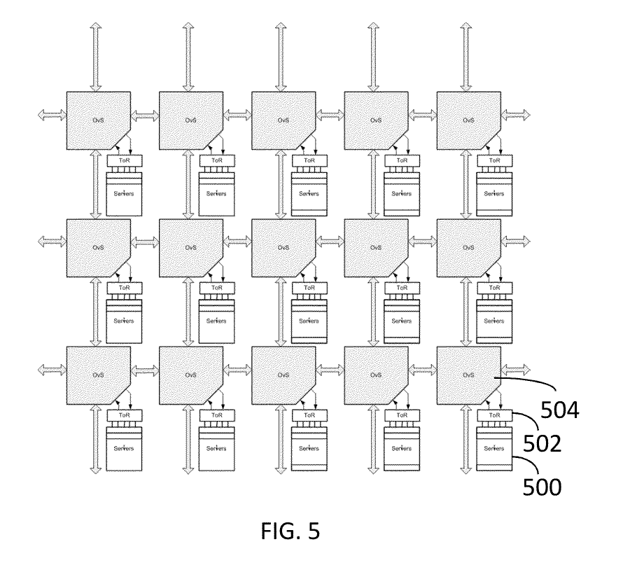

FIG. 5 depicts an N by M server rack arrays in a data center. Each server rack 500 contains dozens of servers and also contains a top of rack (TOR) electrical switch 502. TOR switches 502 aggregate the traffic from each server and generate a flow table for inter-server rack traffic. A layer of optical wavelength switching nodes 504 are introduced above each TOR switch. A TOR switch connects to optical wavelength switching nodes with a number of Dense Wavelength Division Multiplexing (DWDM) signals. Optical wavelength switching nodes multiplex the DWDM signals on a single fiber and broadcast DWDM signals to destination server racks. Meanwhile, the optical wavelength switching node also dynamically selects DWDM signals from neighbors and switches the DWDM signals to a local TOR switch.

In one embodiment, an optical wavelength switching box is equipped with 4 multi-fiber ribbons. Each multi-fiber ribbon, named north, south, west, east respectively, connects to the 4 neighbor server racks. As shown in FIG. 5, an N by M array of optical wavelength switching nodes enables a distributed optical switching network to provide a plurality of path diversities between any pair of server racks.

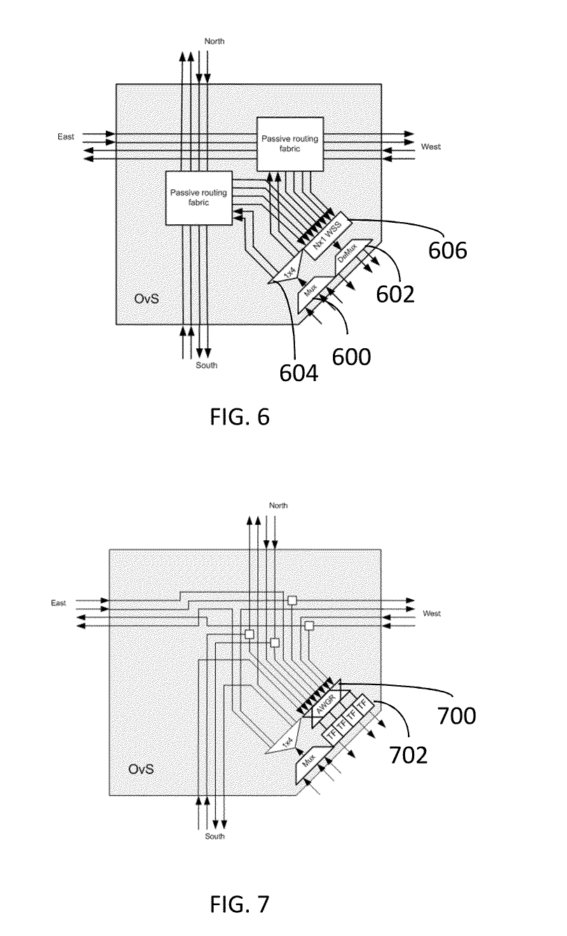

An aspect of the invention is the optical design of the optical wavelength switching node, as depicted in FIG. 6. In one aspect, the optical switching node includes an optical MUX module 600 and an optical DEMUX module 602. The optical MUX 600 and DEMUX 602 respectively connect to optical transceivers 604 and 606 (for example, DWDM SFP+ at 10 Gb/s line rate) on a TOR switch. At the outer bound direction, Individual DWDM optical signals are multiplexed on a single fiber by the optical multiplexer; at the inbound direction, a number of DWDM signals are de-multiplexed by the optical de-multiplexer from a DWDM link that carries the connections from a number of neighbor racks.

In another aspect of the invention, the optical switching node includes a passive 1 by 4 optical splitter at the outer bound direction, which broadcasts the DWDM signals to west, east, north, and south directions. The optical switching node also includes 2 passive fiber routing blocks. One passive routing block processes the connections for east and west directions, while the other passive routing blocks processes the connections for north and west directions. Each passive routing block connects to 2 multi-fiber ribbon cables where every fiber of the multi-fiber ribbon carries broadcasted DWDM signals. The design of passive routing blocks is described below.

In a further aspect of the invention, the optical wavelength switching node also contains an optical wavelength switch. The optical wavelength switch dynamically selects (switches) one or a group of DWDM signals from one or a group of neighbor server racks. The optical wavelength switch may also block (disconnect) the unselected DWDM signals from one or a group of neighbor server racks to the TOR switch. Thus, the bandwidth of any rack to rack connection is able to be dynamically re-configured at wavelength granularity. Finally, the optical switching node may also include one or a pair of optical amplifiers (e.g., Erbium Doped Fibre Amplifiers (EDFAs)) to amplify the DWDM optical signals to compensate for the optical insertion loss by the optics.

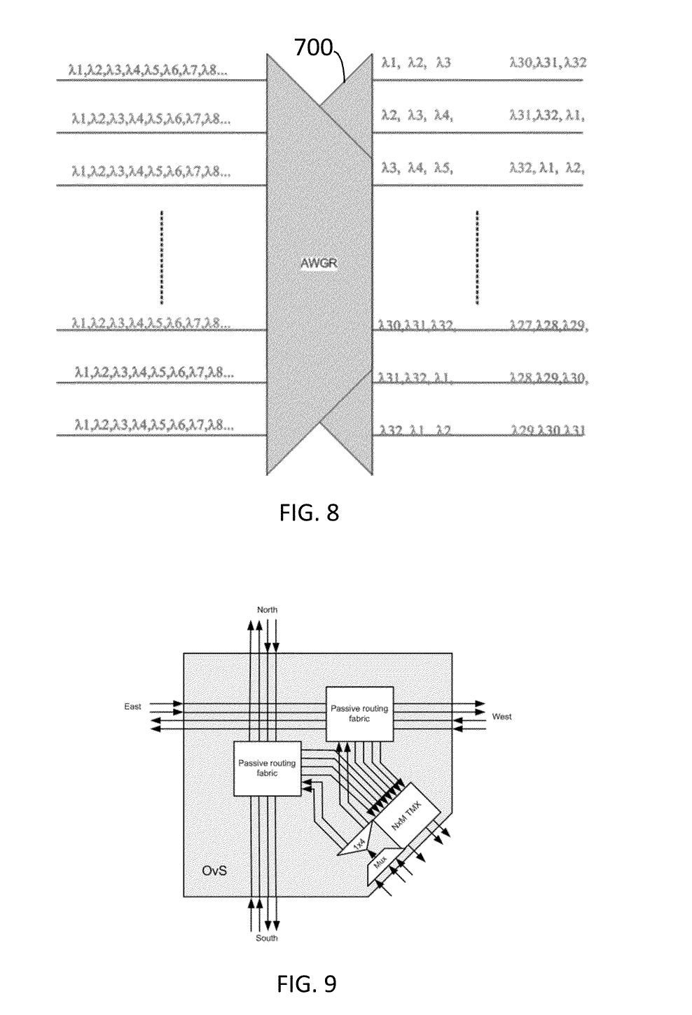

The optical wavelength switch may be implemented by a wavelength selective switch (WSS). In such case, a wavelength selective switch is configured as an N×1 switch to select wavelengths from different sources. The optical wavelength switch may also be implemented by an array waveguide grating router (AWGR) with a tunable filter array. FIG. 7 illustrates AWGR 700 and a tunable filter array 702. The DWDM signals coming from different nodes are shuffled through the AWGR, such as shown in FIG. 8. The tunable filter array 702 can perform a similar wavelength selection function as a WSS, although the wavelength channel plan is different. In these cases, wavelength ID is not reused. Therefore, wavelength contention exists at the optical layer.

The optical wavelength switch element can also be implemented by an optical multicast switch (MCS) plus a tunable filter array, as shown in FIG. 9. In this case, the optical de-multiplexing function is integrated with the optical wavelength switching. Wavelength ID can be reused within a dimension and wavelength contention is eliminated.

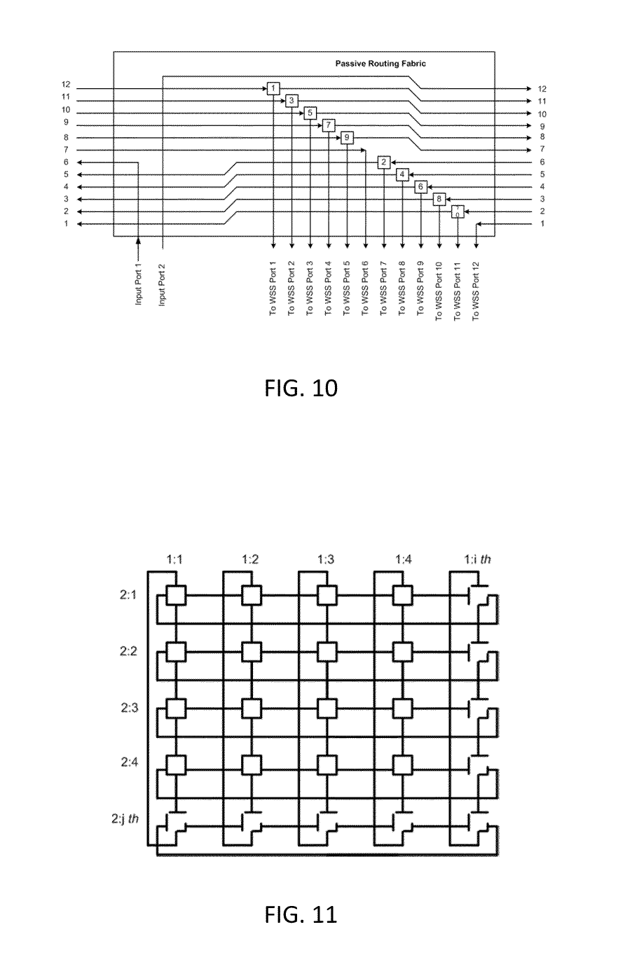

FIG. 10 depicts the design of a passive routing fabric. In the figure, an example for west and east directions is shown. Multiple-fiber ribbons, for example MPO/MTP-12, are used to connect to west and east directions. There are 6 fibers that carry in-bound DWDM optical signals from the east direction. These fibers are mapped as 1, 2, 3, 4, 5 and 6 respectively within a MPO cabling. Fibers 2, 3, 4, 5 and 6 enter a 5-array optical splitter. Partial optical power on these fibers is split and dropped to the optical wavelength switch. The residue optical power on fiber 2, 3, 4, 5 and 6 are shuffled in order to the fibers 1, 2, 3, 4 and 5 on west side of the MPO cabling. On the east side, the optical signal on fiber 1 drops directly to the optical wavelength switch. On the west side, the broadcasted signal from a local rack is sent to fiber 6 of MPO-12 cabling. Similarly, 6 fibers (7, 8, 9, 10, 11 and 12) on the west MPO-12 cabling carry the in-bound optical signals from west side neighbors to the local node. Fibers 8, 9, 10, 11 and 12 enter another 5-array optical splitter, where partial optical power is dropped to an optical wavelength switch. The remaining optical power is expressed to east side fibers 7, 8, 9, 10 and 11 in order. Again, the local broadcasted DWDM signal to the east is sent to fiber 12 on east side MPO-12.

The splitting ratio of each splitter is optimized to balance optical insertion loss among every node to node connection. The splitter ratio of each splitter follows the rule as shown in Table 3-1.

TABLE 3-1
splitter ratio design

| | drop to express |
|---|---|
| splitter # | splitter ratio |
| West 1 | 1:N-1 |
| West 2 | 1:N-2 |
| West 3 | 1:N-3 |
| West 4 | 1:N-4 |
| West 5 | 1:N-5 |
| . . . | . . . |
| West N-1 | 1:1 |

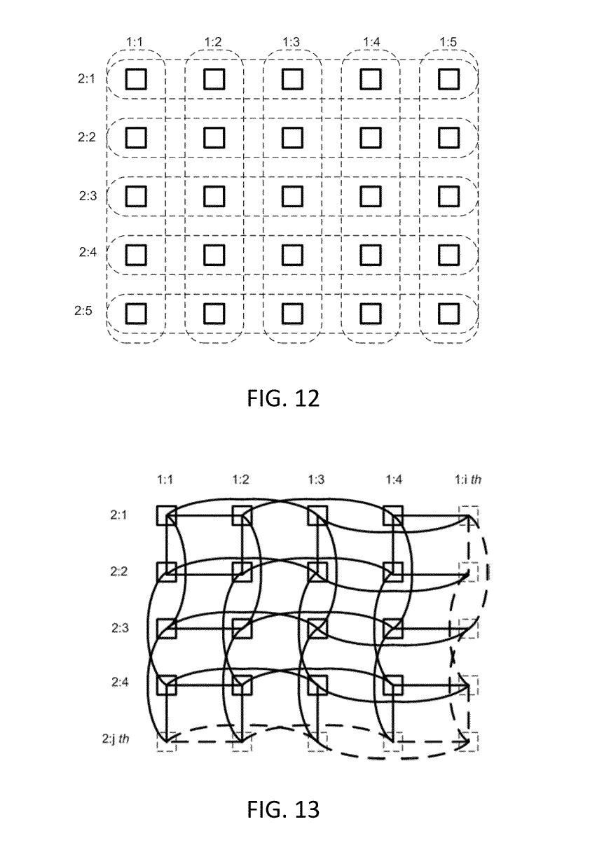

The disclosed design defines unified cabling for every optical wavelength switching node and enables a fully meshed connection among the nodes, as shown in FIG. 12. In this example, up to 13 nodes are fully mesh connected in a group (or a “dimension”) by MPO-12 fiber. MPO-24 can be used to achieve a larger scale interconnection group per dimension.

Thus, a physical two-dimensional torus connection is achieved by two-dimension cabling. FIG. 11 depicts the physical cabling plan for two-dimension N×N server racks in a data center. However, logically, these N×N server racks are inter-connected by an N-array, 2 fliers flattened butterfly network, as show in FIG. 12. In addition, the bandwidth on each connection in the N-array, 2 flier flattened butterfly network is dynamically reconfigured (topology-reconfigured).

The architecture is naturally scalable. A new optical switching node is easy to be added at any location next to the existing N×M server rack array. FIG. 13 depicts a cross over cabling plan to avoid long cabling. The node to node connection crosses one middle node in general. At both ends, a node connects to its neighbor to form an enclosed loop. Thus, cabling length is limited up to a distance as 2. If a new node (N+1) needs to be added, the connection between N−1 node and N node is removed, then 2 cabling from node N−1 to node N+1 and node N to N+1 are installed.

The network size of the described architecture is defined by N, which is restricted by optical power budgeting and technology limits to achieve high port wavelength selective switching. However, another layer of optical wavelength switching nodes can be added for additional dimensions. Thus, an N-array, 4-flier optical switching architecture is enabled or other simplified architectures can be achieved at the cost of long cablings.

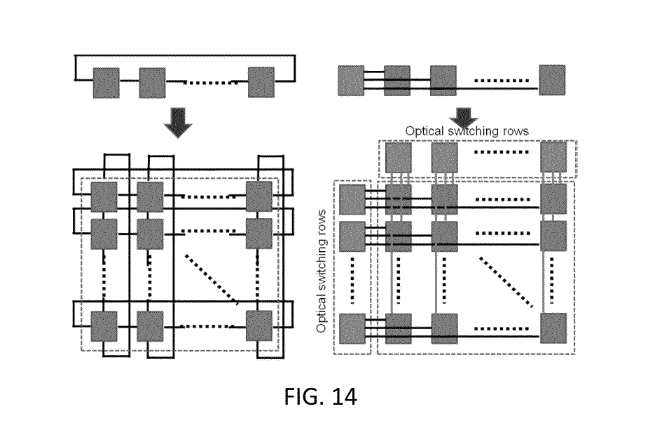

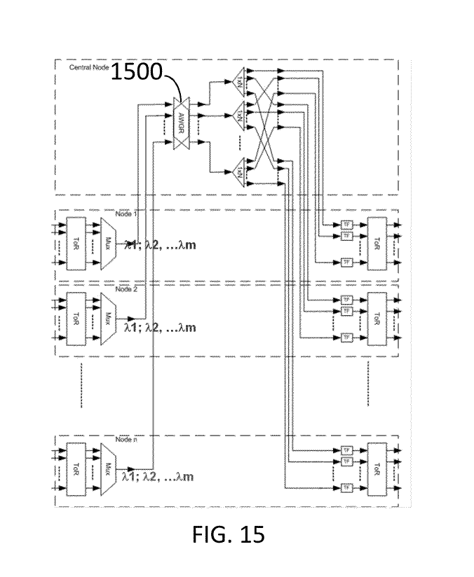

The AWGR based optical switching node of FIG. 7 can utilize a star cable connection, such as shown in FIG. 14. The wavelength shuffling function in a switching node is placed at the end of a row or the middle of the row. The wavelength selection function is still performed by the tunable filter array associated with the TOR switch.

FIG. 15 depicts AWGR 1500 used to shuffle the wavelength from N racks. The shuffled DWDM signals are broadcasted to the receivers of N racks. The tunable filter array on each rack then selects the right wavelength for the receivers. In star cabling, long ribbon cables are used to connect the end of row rack to the racks at the other end.

The disclosed technology provides a novel reconfigurable optical architecture to enable distributed optical switching for data center networking. The solution is easy to scale to support ware-house size data centers with low initial cost and total cost. The solution is also re-configurable to support dynamic traffic patterns for inter-data center networking with low information latency. The solution also benefits from the merits of optical switching technology to dramatically reduce the power consumption and simplify the cabling in the data center.

In the prior art, the core optical switching is centralized so the switching capacity and scalability is limited and therefore is not suitable for large scale data centers. Also, prior art solutions do not exploit SDM to simplify the cabling and thus it is difficult to scale up data center size. While one prior art approach exploits both SDM and WDM technology, it does not introduce wavelength selective switching (WSS) in the design and still relies on electrical switching capability to realize a distributed switching system. Thus, this approach suffers from static and limited node to node optical link capacity and does not resolve the power consumption issue when the link rate scales up.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A system, comprising:
a first rack with a first set of servers and a first top of rack switch;
a second rack with a second set of servers and a second top of rack switch;
a first optical switch connected to the first top of rack switch; and
a second optical switch connected to the second top of rack switch and the first optical switch, wherein the first optical switch and the second optical switch each employ wavelength selective switching.

2. The system of claim 1 wherein the first optical switch and the second optical switch process Dense Wavelength Division Multiplexed (DWDM) signals.

3. The system of claim 1 wherein the first optical switch and the second optical switch broadcast Dense Wavelength Division Multiplexed (DWDM) signals to destination server racks.

4. The system of claim 1 wherein the first optical switch and the second optical switch dynamically select Dense Wavelength Division Multiplexed (DWDM) signals.

5. The system of claim 1 wherein the first optical switch switches Dense Wavelength Division Multiplexed (DWDM) signals to the first top of rack switch.

6. The system of claim 1 wherein the first optical switch is configured for attachment to four multiple optical fiber ribbons for connection to four neighbor server racks.

7. The system of claim 1 wherein the first optical switch includes an optical multiplexer and an optical demultiplexer.

8. A system, comprising:
a first rack with a first set of servers and a first top of rack switch;
a second rack with a second set of servers and a second top of rack switch;
a first optical switch connected to the first top of rack switch; and
a second optical switch connected to the second top of rack switch and the first optical switch, wherein the first optical switch and the second optical switch each employ an array waveguide grating router with a tunable filter array.

9. The system of claim 8 wherein the first optical switch and the second optical switch process Dense Wavelength Division Multiplexed (DWDM) signals.

10. The system of claim 8 wherein the first optical switch and the second optical switch broadcast Dense Wavelength Division Multiplexed (DWDM) signals to destination server racks.

11. The system of claim 8 wherein the first optical switch and the second optical switch dynamically select Dense Wavelength Division Multiplexed (DWDM) signals.

12. The system of claim 8 wherein the first optical switch switches Dense Wavelength Division Multiplexed (DWDM) signals to the first top of rack switch.

13. The system of claim 8 wherein the first optical switch is configured for attachment to four multiple optical fiber ribbons for connection to four neighbor server racks.

14. The system of claim 8 wherein the first optical switch includes an optical multiplexer and an optical demultiplexer.
